(19) United States
(12) Patent Application Publication
(10) Pub. No.: US 2010/0116955 A1
(43) Pub. Date: May 13, 2010

(54) TOWEL HOLDER AND METHOD OF MANUFACTURE

(76) Inventors: Richard J. Hayes, Fountain Valley, CA (US); Douglas A. Hayes, Fountain Valley, CA (US)

Correspondence Address: STETINA BRUNDA GARRED & BRUCKER, 75 ENTERPRISE, SUITE 250, ALISO VIEJO, CA, 92656, US

(21) Appl. No.: 12/270,274

(22) Filed: Nov. 13, 2008

(51) Int. Cl. A47B 96/06; B29C 70/68

(52) U.S. Cl. 248/206.5; 264/241

(57) ABSTRACT

The present invention includes a flexible device incorporating a magnet, and the method of manufacturing the device, wherein said device is used for holding an exercise towel against the metallic surfaces of fitness machines to promote the hygienic use of fitness towels. The device comprises an elongate strap having opposed and first and second end portions. An opening is provided in the first end portion for receiving a towel and a magnet is embedded within the second end portion for attaching the metallic surface of fitness machine. The invention includes a method for producing the device by using an open mold elongate cavity with a post attached to the base of the cavity of a first end of the elongate cavity for forming the opening in the device, and a metal post formed into the base of the second end of the cavity, the steps including: placing a magnet into the cavity at the second end, and positioning said magnet in proper location and orientation onto the top of said metallic post; filling said cavity with a liquid to cover the magnet in the second cavity end; and solidifying the liquid into a flexible material to form the device.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND

The present invention relates generally fitness accessories for the hygienic and convenient use of exercise towels in a fitness facility and a method of making the device. More specifically, the invention includes a device incorporating a magnet for holding an exercise towel against the metallic surfaces of fitness machines such as found in fitness facilities. The present invention additionally includes a method of manufacturing the device.

It is common practice for fitness facilities to require members to use exercise towels as a condition for use of the facilities. Such towels are used for wiping away perspiration during or after the workout on the body of the exerciser, or directly upon the exercise equipment after use. It is common courtesy for an exerciser to wipe perspiration from the seating and handles of the exercise equipment after use for hygienic use by the next person using the machine.

During exercise on a fitness machine, the fitness facility user must decide where to place the towel during the workout. Although a towel can be placed in a pocket or waistband during a workout, many modern workout clothing outfits do not have suitable pockets or waistbands to accommodate a towel. Also, a fitness machine user can place the towel around the back of the neck, however, it is likely that the towel will fall to the ground during the workout. Also, placing the towel in a pocket, waistband or around the neck can restrict movement of the exerciser or otherwise interfere with movement during the exercise. Furthermore, the exerciser can chose to place the towel on the fitness equipment at the risk of having the towel fall to the floor or interfere with the operation of the exercise machine. Having the towel contact the floor is undesirable for a variety of hygienic reasons particularly in light of the recent increase in occurrences of sports related drug resistant microbes such as antibiotic-resistant Staphylococcus aureus bacteria (MRSA).

Prior devices have been used and proposed to provide magnetic support of a towel on exercise equipments wherein the magnet is embedded directly into the towel such as U.S. Pat. No. 4,885,195, the substance of which is incorporated herein by reference. However, it would be desirable for a universal device that would be attachable to a standard type of workout towel for engaging the metal surfaces of exercise equipment and detachable for subsequent washing of the towel. As such, there is a long standing need in the art for a simple cost effective device that can be used to secure a standard workout towel to the magnetic surfaces of fitness equipment for the hygienic use of the towel. Furthermore, there is a need for a method for producing such a device on a cost effective and efficient basis. The device and method of present invention addresses these particular needs, as will be discussed in more detail below.

### BRIEF SUMMARY

The present invention includes a flexible device incorporating a magnet, and the method of manufacturing the device, wherein the device is used for holding an exercise towel against the metallic surfaces of fitness machines to promote the safe hygienic use fitness towels. The device comprises an elongate strap having opposed and first and second end portions. The device also has a continuous peripheral edge and top and bottom surfaces. An opening is formed in the first end portion for receiving a towel and a magnet is embedded, at least partially, within the second end portion for allowing the device to be attracted to and attached the metallic surface of fitness machine.

In the first embodiment of the device of the present invention, the end portions have a greater cross-sectional depth than the depth of the intervening strap. This allows the middle strap portion to be more flexible. The devices is formed preferably from a semi-transparent flexible plastic or rubber like material. It is contemplated by the present invention that the magnets may include an informational sticker affixed to one or both sides of the magnet before it is embedded into the device structure. Because the device is formed from a semi-transparent material, the indicia found on the magnet can be seen through the material. As such, the device can be uses as a marketing tool for and can include a corporate logo or other similar information.

The method of the invention includes a method for producing the device by using an aluminum or other non-magnetic material open mold elongate cavity with a post attached to the base of the cavity of a first end of the elongate cavity for forming the opening in the device, and a metal post formed into the base of the second end of the cavity. The cavity may be formed into a tray that may include multiple like cavities. The metal post is embedded into the base of the cavity and extends through the tray to be exposed on the underside of the tray. A magnet is position on the bottom of the tray against the metal post, effectively polarizing the post in a particular magnetic orientation. The method steps include placing a magnet into the cavity at the second end, and positioning said magnet in proper location and orientation onto the top of said metallic post. Because the metal post is magnetized in a particular orientation, the magnet will be positioned in proper orientation. In addition, the magnet can be centered on the post so that it is in proper alignment when a liquid is introduced into the mold. A step of the method includes filling the cavity with a liquid to cover the magnet in the second cavity end and then solidifying the liquid into a flexible material to form the device. Typically, the material will be introduced as a room temperature liquid that solidifies into a suitable flexible material.

Another embodiment of the present invention involves the formation of the elongate strap with silicon rubber. The silicon rubber body is formed with the first end including a circular ridged structure such as washer that is included in the mold during forming of the body, with the washer aperture aligned with the opening in the first end. The second end is formed with a slot opening that allows a magnet to be inserted into the body after the silicon rubber has cooled. Because the silicon rubber body is formed using hot liquid silicon material, the magnet is introduced after formation of the body as heat exceeding 180 degrees Fahrenheit will degrade a rare earth magnet.

Another embodiment of the present invention includes a foil elongate strap. The foil strap is formed from two pieces of complimentary foil, with an adhesive that holds the pieces together when placed in contact. A first end of the foil strap includes a circular rigid structure, such as a washer, embedded between the foil strips, and with the opening placed alignment with openings in the foil strips to form an opening. A second end includes a circular magnet embedded between the strips of foil to provide the magnetized second end. As such the result is an elongate foil strip, having a reinforced opening in a first end for receiving an athletic towel, and a second end incorporating a magnet for contacting the metal surface of a fitness machine.

In yet another embodiment of the present invention, the elongate strap is formed from shrink tubing wherein a washer in incorporated into the first end and a magnet is incorporated into the second end. A hole is formed in the first end in alignment with the opening of the washer, and the ends of the shrink tubing are heat sealed. As such, the washer opening receives the towel and the second end of the strap includes the magnet for engaging the metal surface of a fitness machine.

In an another embodiment of the present invention, the device of the first embodiment of the present invention, the device additionally includes a metal ring structure, such as a washer, embedded into the first end of the strap to provide additional structural support to the strap opening.

In a further embodiment of the present invention, the towel holder device is formed from two mirror image elongate pieces of elastic material. On the first end of both pieces, a cavity is formed so that when the two pieces are placed together, they envelope a magnet. On the second end, apertures are formed so that when the pieces are placed together the apertures align to form a single aperture for receiving a towel. The pieces are fixed together using a suitable adhesive. In a variation on the aforementioned embodiment, a recessed area can be formed around the apertures of the second end, sized to receive a rigid metal structure such as a washer. A washer is placed between the pieces along with the magnet to be enveloped when the two pieces are fixed together.

In yet a further embodiment of the present invention, an elongate flexible body is formed from a suitable flexible material having top and bottom surfaces, with an aperture formed in the second end. A cavity is formed in the first end to receive a disc shaped magnet with a second tier recessed area, formed higher than the cavity but lower than the bottom surface of the flexible body. A flexible cover is provided to fit within the corresponding second tier recess area and is fixed into place with an adhesive, enveloping the magnet within the flexible body.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a first embodiment of the device of the present invention;

FIG. 2 is a cross sectional cutaway view of the elastic body of the first embodiment of the device of the present invention;

FIG. 3 is a top plan view of the first embodiment of the device of the present invention;

FIG. 4 is the side view of the first embodiment of the device of the present invention;

FIG. 5 shows the first embodiment of the device of the present invention engaged with a vertical metallic surface and holding an athletic towel;

FIG. 6 shows the device of the first embodiment of the device of the present invention engaged with a horizontal metallic surface and holding an athletic towel;

FIG. 7 is a cross sectional view of the towel of the first embodiment of the device of the present invention engaged with a vertical metallic surface;

FIG. 8 is a top plan view of a portion of open cavity molds used in the method to form the device of the first embodiment of the present invention;

FIG. 9 is a cross sectional view of a mold cavity used in the method to form the device of the first embodiment of the present invention;

FIG. 10 is a cross sectional view of the cavity and mold including the magnetic insert to demonstrate the method forming the device of the first embodiment of the present invention;

FIG. 11 is a cross sectional view of the mold, with the device material included within the mold to form the first embodiment of the device of the present invention in accordance with the method of the present invention;

FIG. 12 is a cross sectional view of the mold along with a cross sectional view of the first embodiment of the device of the present invention being removed from the mold in accordance with the method of the present invention;

FIG. 13 is a perspective view of a second embodiment of the device of the present invention;

FIG. 14 is a cut away view of a second embodiment of the device of the present invention;

FIG. 15 is top plan view of a second embodiment of the device of the present invention;

FIG. 16A is a cross sectional view of the device of the second embodiment of the device of the present invention;

FIG. 16B is a cross sectional view of the device of a third embodiment of the device of the present invention, using corresponding foil parts;

FIG. 17 is a perspective view of a fourth embodiment of the device of the present invention using shrink tubing;

FIG. 18 is a cut away view of an alternate embodiment of the first embodiment of the present invention incorporating a washer to provide structural support to the aperture;

FIG. 19 is a cross sectional exploded view of a fifth embodiment of the present invention showing two piece construction;

FIG. 20 is a cross sectional view of the fifth embodiment of the present invention showing the two piece construction fixed in place;

FIG. 21 is a cross sectional view of an alternate embodiment of the fifth embodiment of the present invention incorporating a washer to provide structural support to the aperture;

FIG. 22 is a cross sectional exploded view of an sixth embodiment of the present invention showing two piece construction wherein the second piece covers a magnet to be incorporated into the device; and

FIG. 23 is a cross sectional of the sixth embodiment of the present invention showing the two piece construction fixed in place.

### DETAILED DESCRIPTION

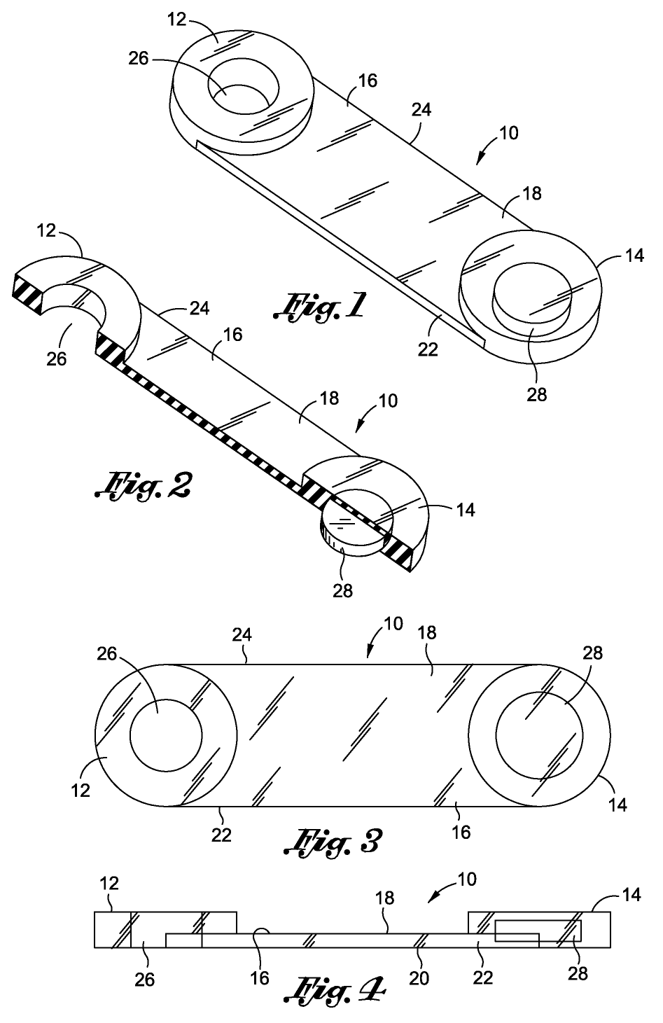

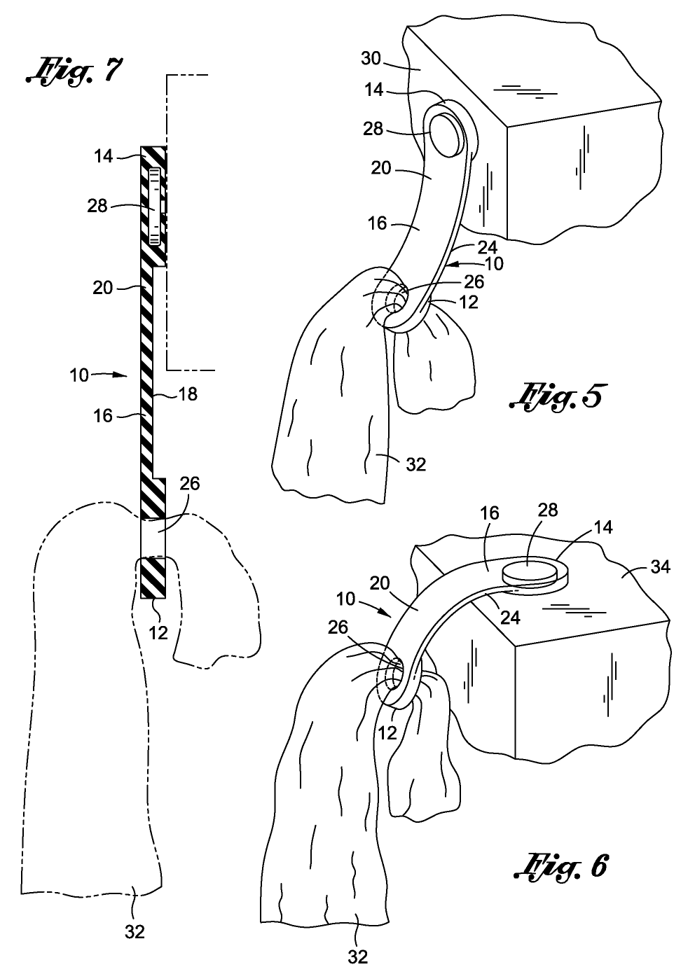

Referring particularly to FIGS. 1 through 4 a first embodiment of the present invention is shown of the towel holder device 10. The towel holder device 10 is formed of a strong flexible rubber like material preferably polyurethane but can also be formed of silicone rubber. In this embodiment, the flexible material is semitransparent, however, the flexible material could be formed of an opaque flexible material. A first raised circular end 12 is interconnected to a raised circular end 14 by an elongate strap 16. The elongate strap 16 includes a generally plainer top surface 18 and generally planar bottom surface 20. This strap also includes peripheral edges 22 and 24. The strap 16 interconnects the circular ends 12 and 14, and end 14 includes aperture 26. The aperture 26 is preferably a circular open used to allow the passage of a athletic towel to be held in place as shown in greater detail with respect to FIGS. 5 through 7. Although the embodiment of FIG. 1 shows a circular aperture 26, it is understood the aperture can be any suitable shape. On the opposite end of the strap 16 is the second circular end 14 that includes a magnet 28 embedded within the flexible device 10. Preferably, the elastic material of the device 10 is semitransparent to allow the magnet 28 to be seen through the exterior surface of the device 10. Preferably, the magnet would include visible indicia such as a logo to be included on the surface of the magnet and viewable through the surface of the device 10. As such, the device 10 can be used as a promotional item for gymnasiums or corporations that could include their logo on the magnet surface.

The device 10 is shown in operation in FIGS. 5 through 7. In operation, the second end of the device 10 incorporating the magnet 28 is placed against a metallic surface of a fitness machine. The soft flexible material of the device 10 will not damage the metallic surface 30 when engaged. The magnet is of sufficient strength to forcefully engage the metallic surface 30 and to support the weight of an athletic towel 32 while remaining in place. As shown in FIGS. 5 and 7 the device can be attached on the vertical side of the metallic surface 30, and the magnet has sufficient strength to remain in place even with the athletic towel incorporated through the aperture 26. The soft flexible surface of the device 10 additionally adds friction to hold the device in place. FIG. 6 shows the device 10 engaged with a horizontal metallic surface 34. Utilizing the magnet 28 on a horizontal surface, increases the weight the device 10 is capable of supporting. The magnet 28 is preferably formed of a three quarter inch diameter rare earth magnet having ⅛ inch thickness. The device attached to a vertical surface is capable of holding approximately three (3) lbs.

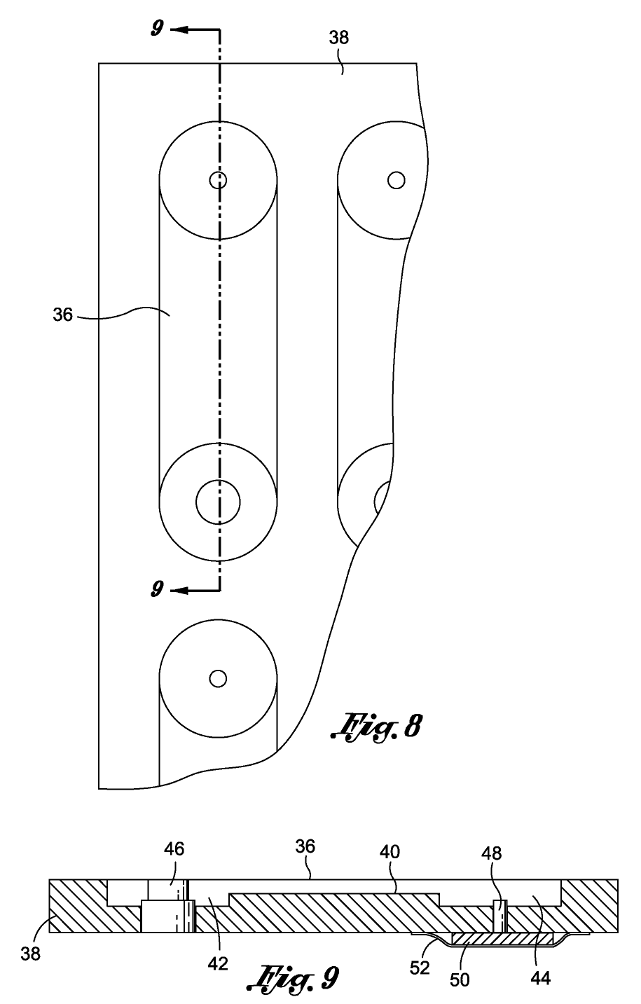

Referring to FIGS. 8 through 12 there is shown a method for manufacturing the athletic towel holder device as described in FIGS. 1 through 7. FIG. 8 shows a top view of the open cavity urethane mold 36. FIGS. 9 through 12 show a cross-section 9-9 of the mold 36. It is contemplated by the method that the method can be accomplished by a single mold, or upon a tray 38 that incorporates several open cavity molds as shown in the example of FIG. 8.

Referring particularly to FIG. 9 there is shown a cross-figure 9-9 of the open cavity mold 36 of FIG. 8. The open cavity includes a shallow region 40 used for forming the strap 16 as shown in FIG. 12. A first circular end 42 and second circular end 44 includes a deeper open cavity than the shallow strap region 40 to form the device as shown in FIG. 1. The first end 42 includes a post 46 formed into the base of the cavity extending the entire depth of the first end 42. In the second cavity end 44 a metallic post 48 is formed into the base of the cavity and which extends through to the bottom surface of the tray 38 pool. A mold magnet 50 is fastened to the bottom of the tray 38 by a fastening means such as a tape 52 such that magnet 52 contacts the post 48 thereby magnetizing the post in a desired polarity.

Referring particularly to FIG. 10 the magnet 28 is centered onto the post 48 within the open cavity of the second end 44. The post 48 aids in centering the magnet within the cavity 44, as the post 48 is magnetized for a specific polarity by the magnet 50 the magnet 28 can only be positioned on the post 48 in the correct desired polarity. If the magnet is inserted incorrectly the post 48 would repel the magnet and not allow it to rest in position within the cavity 44.

As shown in FIG. 11, the open cavity receives a liquid material 54 that is poured into the open cavity mold and allowed to cure and harden to form the flexible body of the device 10 as shown in FIG. 12. The liquid material envelopes the magnet 28 and forms around the post 46 to form the aperture 26 as shown in FIG. 12. The liquid material is typically a two part polyurethane material that is easy to utilize, but can also be rubber. The use of an open cavity mold is preferred in using the rare earth magnets as the earth magnets of sufficient strength will lose their magnetic attractive properties upon reaching a temperature of 180 degrees or more. As such, the liquid plastic material poured into the mold as shown in FIG. 11 will be introduced into the mold at a temperature below 180 degrees, and allowed to cure to be removed from the mold as shown in FIG. 12.

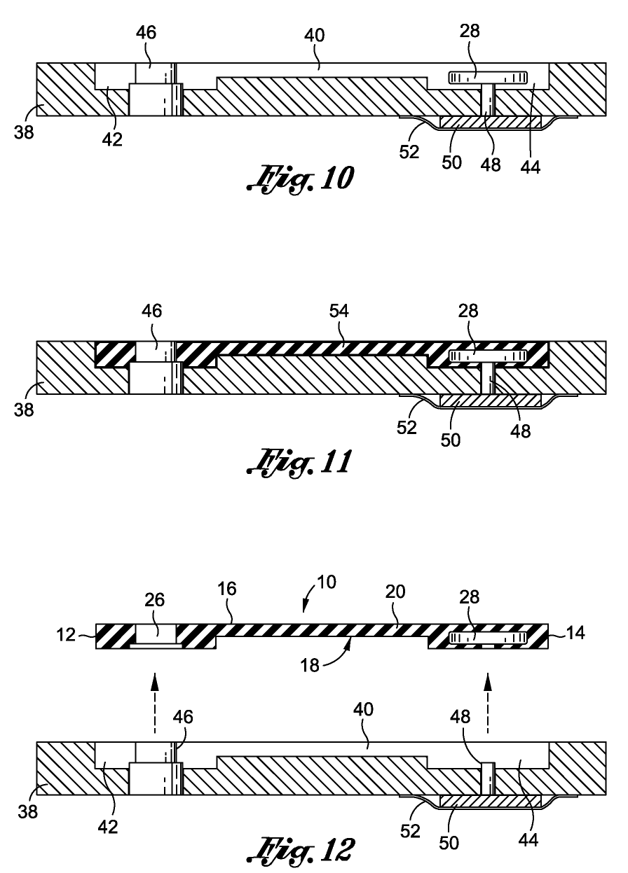

Referring particularly to FIGS. 13 through 16A, there is shown a second embodiment of the present invention showing a device 54. The device 54 operates in the same fashion as the device 10 shown in FIGS. 1 though 7, however, the device is formed by single piece silicone rubber.

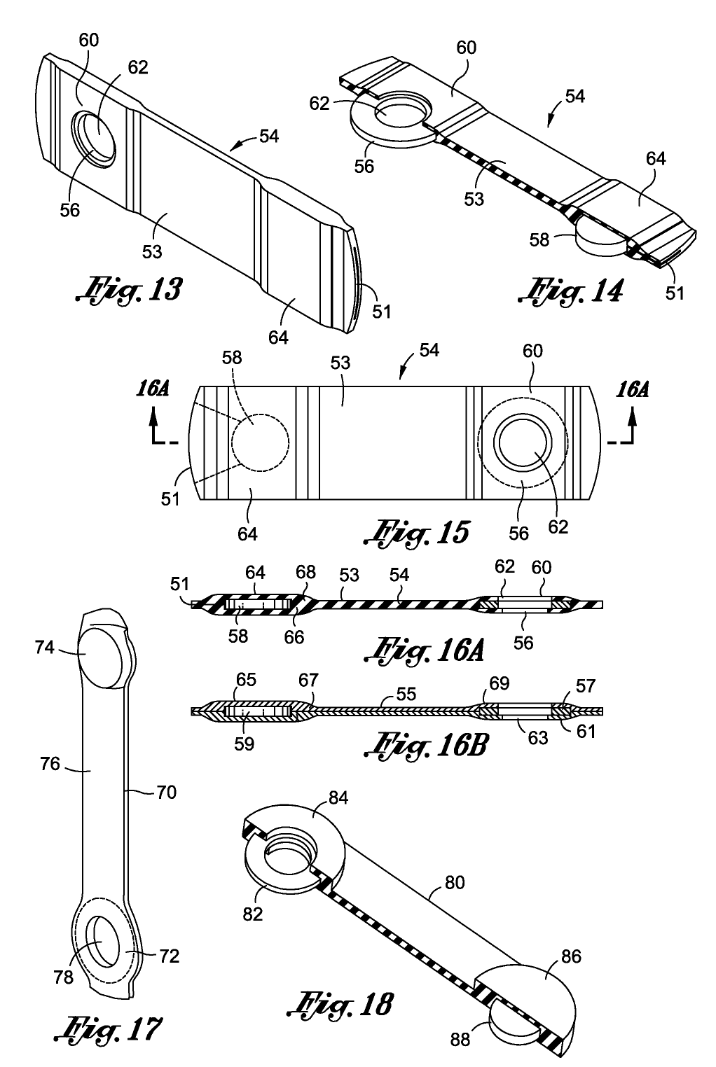

More particularly, the device 54 includes a first end 60 incorporating an aperture 62 for receiving an athletic towel. The first end 60 incorporates a washer 56 within the silicone rubber of the device 54. Elongate strap 53 interconnects the first end 60 with the second end 64. The second end 64 has a rare earth magnet 58 embedded between the silicone layers for providing the magnetic attraction necessary for engaging the device 54 against the metallic surface of a fitness machine. An opening 51 is provided in the formation of the silicone rubber to insert the magnetic disk 58 to the interior of the second end 64. The magnet 58 is inserted after formation of the silicone rubber because the silicone rubber device 54 is produced in a high heat exceeding 180 degrees. Rare earth magnets degrade above a certain heat threshold and accordingly, the magnetic disk 58 is inserted after the device 54 is formed. The opening 51 may be sealed after insertion of the disk 58 to prevent the magnetic disk 58 from becoming dislodged from the device 54. FIG. 14 shows a cutaway view of the device 54 showing the washer 56 and the magnetic disk 58. FIG. 16A shows a cross-sectional view along the lines 16A in FIG. 15.

Referring particularly to FIG. 16B there is shown a third embodiment of the present invention showing a device 55. The device 54 operates in the same fashion as the device 10 shown in FIGS. 1 though 7, however, the device is formed by a layered foil configuration. A washer 57 and rare earth magnet 59 are layered between two sections of elongate foil that are held in place by an adhesive. FIG. 16B shows the device 55 in cross sectional view with a first end 61 incorporating an aperture 63 for receiving an athletic towel. An opening is formed in both long strips of foil before they are placed together by an adhesive, in alignment with the aperture 63 of the washer 57. It is also contemplated that the aperture can be formed once the washer is placed between the foil strips by punching out the foil in the aperture of washer 57. The washer 57 provides structural rigidity to the device 55 so that a athletic towel may be received within the aperture 63 without degrading the foil structure of the device 55. A second end 65 has a rare earth magnet 59 embedded between the foil layer, and providing the magnetic attraction necessary for engaging the device 55 against the metallic surface of a fitness machine. As shown in FIG. 16B the rare earth magnet 59 is embedded between a first layer foil 67 and a second layer foil 69. Likewise, a washer 57 is embedded between the layers of foil 67 and 69. An aperture formed in the foil 67 and 69 is in substantial alignment with the opening of the washer 57.

Referring particularly to FIG. 17 there is shown a third embodiment of the present invention showing a device 70. The device 70 is formed with shrink tubing where a washer 72 is placed within the shrink tubing sleeve and a rare earth magnetic 74 is inserted in the opposite end of the shrink tubing. The shrink tubing is heated to a desirable temperate such that the shrink tubing envelopes the washer 72 and rare earth magnet 74 forming an elongate device 70 with the tubing between the washer 72 and magnet 74 forming the interconnecting strap 76. An aperture 78 is pierced through the tubing in alignment with the opening of the washer 72. As such, the device 70 as shown in FIG. 17 may operate in similar fashion to the first embodiment as shown in operation in FIGS. 5 to 7.

Referring particularly to FIG. 18, a fourth embodiment of the present invention is shown as device 80. The device 80 is structurally similar to the device 10 as shown in FIG. 2, however, in the fourth embodiment the device 80 additionally incorporates a washer 82 into the first end 84 where the opening of the washer 82 is in substantial alignment with the opening of the first end 84. As in the first embodiment, a rare earth magnet 88 is embedded within the second circular end 86. The device 80 is shown in cross-sectional view, in FIG. 18 and in operation acts similar to the device 10 as shown in FIGS. 5-7. The washer 82 provides additional support for the aperture 90. The device 80 of FIG. 18 may be formed in accordance with the method of the present invention as shown in FIGS. 8-12, with the additional step of the placement of the washer 82 upon the post 46. Accordingly, when liquid is introduced into the open cavity 54 it additionally envelopes the washer 82 as well as the rare earth magnet 88. The washer 82 provides additional structural support to the first circular end 84 of the device 80.

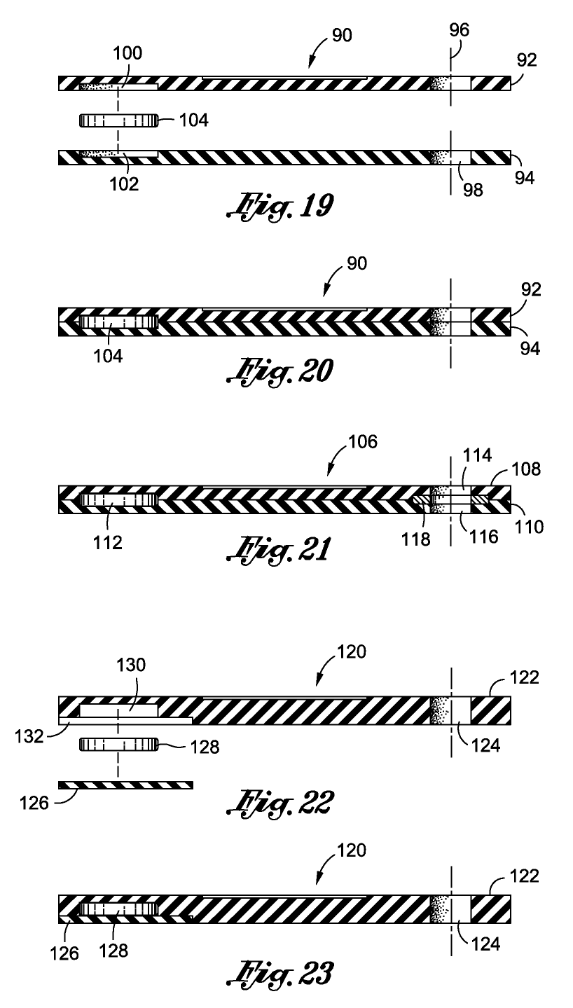

Referring particularly to FIGS. 19 and 20 there is shown a fifth embodiment of the present invention as device 90. The device is shown in FIGS. 19 and 20 as cross-sectional views of the device 120.

The device 90 is formed from two strips of elongate elastic material 92 and 94. In a first end of the device 90 apertures 96 and 98 are formed in the strips 92 and 94. The strips 92 and 94 are formed from an elastic material to provide flexibility. The strips 92 and 94 additionally include recesses 100 and 102 respectively on the second end of the device 90. A magnetic disc 104 is provided to the sandwiched between the layers 92 and 94, and the layers 92 and 94 are secured together by an adhesive. The device 90 will operate in the same fashion as the first embodiment of the present invention shown in FIGS. 1 though 7, however, the device is formed by separate strips 92 and 94. An alternative to the fourth embodiment is shown in FIG. 21. The device 106 shown in FIGS. 21 is a cross-sectional view. In FIG. 21 a device 106 is shown with formed of two strips 108 and 110 and a magnetic disk 112 sandwiched between the layers secured together by an adhesive. The layers 108 and 110 additionally include recesses formed around openings 114 and 116 to form a single aperture. A metallic washer 118 is inserted into the recesses and sandwiched between layers 108 and 110. the washer provides additional structural support for the aperture formed by aperture 114 to 116.

Referring particularly to FIGS. 22 and 23 is shown a sixth embodiment of the present invention and is shown as device 120. Again, the device 120 operates in the same fashion as the device 10 as shown in FIGS. 1 through 7, however, the device is formed from two pieces of material. Elongate flexible strip 122 is formed having an aperture 124 formed in the first end of the device 120, the aperture 124 used for receiving an athletic towel. The device shown in FIGS. 22 and 23 is a cross-sectional view of the device 120. As shown in FIG. 22 a second piece of flexible material 126 is provided to act as a cover for securing a rare earth magnet disk 128 into a recess 130. A shallow recess 132 is additionally provided in strip 122 to mate with the flexible strip 126 and is shown in place in FIG. 23. The strip 126 is secured to the strip 122 by an adhesive material to envelope the magnetic disk 128 and to hold it in place within the device 120.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A device for holding an athletic towel comprising:
a. an elongate strap defining opposed, generally planar surfaces, a continuous peripheral edge, and opposed and first and second end portions;
b. an aperture disposed within the first end portion of said strap; and
c. a magnet, at least partially embedded within the second end portion of said strap.

2. The device of claim 1 wherein the cross section of the at the first end portion and said second end portion is greater than the cross section of a middle portion of the strap between said first and second end portions.

3. The device of claim 1 wherein a magnet is embedded between the opposed surfaces of said strap.

4. The device of claim 1 wherein said aperture provides an opening through the opposed surfaces of the strap sized to receive a towel.

5. The device of claim 1 wherein said aperture is elastically deformable.

6. The device of claim 1 wherein said strap is formed from an elastic material.

7. The device of claim 1 wherein said strap said first end portion includes a ring structure with an opening aligned with said aperture.

8. The device of claim 7 wherein said ring structure is embedded between said opposed planar surfaces of said strap.

9. The device of claim 7 wherein said ring structure is a washer.

10. The device of claim 1 wherein said magnet is heat shrunk within the second end portion of said strap.

11. The device of claim 7 wherein said ring structure is heat shrunk within said first end portion of said strap.

12. The device of claim 1 wherein said strap is formed from two adhesively fixed strips of flexible material to envelope a ring structure around said aperture in said first end portion.

13. The device of claim 1 wherein said strap is formed from two strips of adhesively fixed flexible material to envelope a magnate in said second end portion.

14. A method of manufacturing a device for holding an athletic towel by use of a open mold including an elongate cavity defining opposed first and second cavity ends, said first cavity end including a post formed into the base of the cavity extending the entire depth of the first end of said cavity, said second cavity end incorporating a post formed into the base of the cavity and extending through a portion of the depth of the second end of such cavity, the method comprising:
a. placing a magnet into the second cavity end, and positioning said magnet onto the top of said post;
b. filling said elongate cavity with a liquid to cover the magnet in the second cavity end;
c. solidifying the liquid into a flexible material; and
d. removing the formed device from the mold,

15. The method of claim 14 wherein said post is metallic capable of magnetic attraction for placement of the magnet in proper position within the second cavity end.

16. The method of claim 14 wherein said post is metallic and magnetized with a specified polarity, and wherein said positioning of said magnet onto the metallic post will orient the magnet to a desired polarity;

17. The method of claim 16 wherein said metallic post extends through the base of the cavity to contact a magnet to magnetize the post in a desired polarity.

18. The method of claim 14 wherein said the solidified flexible material is semi transparent.

19. The method of claim 18 further comprising the step incorporating graphics on the at least one side of said magnet.

20. The method of claim 19 wherein the step of incorporating graphics onto at least one side of said magnet includes the use of a sticker placed on said magnet.

21. The method of claim 14 wherein said post formed into said first end of said cavity is generally circular to form a generally circular opening when formed device is removed from the mold.

22. The method of claim 14 wherein said magnet is a generally disk shaped magnet.
